(19) United States
(12) Patent Application Publication
(10) Pub. No.: US 2022/0135838 A1
(43) Pub. Date: May 5, 2022

(54) FUNCTIONAL COATINGS COMPRISING MICROSPHERES AND NANOFIBERS

(71) Applicant: NITTO DENKO CORPORATION, Osaka (JP)

(72) Inventors: Guang Pan, Carlsbad, CA (US); Kaoru Ueno, Fallbrook, CA (US)

(21) Appl. No.: 17/573,451

(22) Filed: Jan. 11, 2022

Related U.S. Application Data
(63) Continuation of application No. PCT/US2020/041695, filed on Jul. 10, 2020.
(60) Provisional application No. 62/873,765, filed on Jul. 12, 2019.

(51) Int. Cl. C09D 183/06; C09D 5/00; C09D 7/62; C09D 7/40; C09D 7/20; C09D 7/65; B05D 1/00

(52) U.S. Cl. CPC C09D 183/06; C09D 5/00; C09D 7/62; B05D 1/60; C09D 7/20; C09D 7/65; C09D 7/70

(57) ABSTRACT

Described herein are coating dispersions and coatings based on hydrophobic nanofiber and silicone microbeads dispersed in a hydrophobic polymer matrix that provide a damage tolerant hydrophobic, superhydrophobic, and/or snowphobic capability. Methods of creating snow resistant materials by employing the aforementioned coatings are also described.

### CROSS-REFERENCE TO RELATED APPLICATIONS

This application is a continuation of International Application No. PCT/US2020/041695, filed Jul. 10, 2020, which claims the benefit of U.S. Provisional Application No. 62/873,765, filed Jul. 12, 2019, both of which are incorporated by reference herein in their entirety.

### FIELD

The present disclosure relates to hydrophobic, superhydrophobic and snowphobic composites, including coatings of said composites for such uses as water, ice and snow repellents.

### BACKGROUND

In many settings, the buildup of water, ice, and snow can create undesirable results. These issues can include corrosion due to water intrusion, loss of visibility due to water buildup, and ice and snow buildup on roads, signage, vehicles and buildings. On windshields of motor craft such as automobiles, boats, and aircraft, complex systems including wipers, air jets, and passive systems such as deflectors are designed to remove water. The buildup of ice on the leading edges and on the upper wing surfaces of airplanes and rotor blades of helicopters can create hazardous conditions by changing the shape of the wing and/or increasing the total weight, resulting in stall or loss of performance. In addition, deposited ice can suddenly dislodge, resulting in an unexpected change in characteristics and possibly loss of control. Ice and snow buildup on walkways, roadways, and bridges is inherently dangerous due to loss of traction. Highway overpasses, bridges, and power lines also may create hazardous conditions by falling ice and snow, resulting in damage to vehicles and personal injury to persons below.

There are many kinds of snow and they comprise vastly divergent water contents. For example, dry or light snow comprises a very low water content, while heavy or wet snow has a high-water content. This considerable difference in water content creates a problem with respect to the anti-snow performance of known hydrophobic coatings. Wet snow creates a water layer between the conventional hydrophobic coatings and the snow which allows the hydrophobic coating to interact with the water, and due to the high water contact angle, the water layer will slide off the coating taking along the upper layer of snow. Dry snow, on the other hand, with its low water content, forms minimal to no water layer between the snow and the superhydrophobic coating. This lack of a water layer causes the dry snow to accumulate on the surface.

To combat ice and snow accretion on highway overpasses, signage and power lines, many municipalities use anti-snow/anti-ice coatings such as fluorinated resin based coatings. While some of these coatings are commercially available (e.g., HIREC100) they can be expensive to produce, are difficult to work with, and they are harmful to both animals and humans.

As a result, there is a continuing need for a new anti-snow surface coating with improved hydrophobic performance, reduced cost, and low toxicity.

### SUMMARY

The present disclosure generally relates to composites. More particularly, but not exclusively, the present disclosure relates to a composite having microbeads dispersed within and protruding through a polymer matrix. More particularly, but not exclusively, the present disclosure relates to a composite coating comprising a micro/nano rough surface thereof.

Some embodiments include a superhydrophobic coating dispersion comprising: 10 to 75 wt % of an organosilane, wherein the organosilane comprises a low surface energy polymer, a hydrolyzed alkoxysilane, a hydrolyzed fluoroalkylalkoxysilane, or a combination thereof; 20 to 60 wt % hydrophobic inorganic nanofibers disposed within the organosilane; 0.5 to 40 wt % microbeads dispersed in the organosilane; and a polar solvent.

Some embodiments include a coating made by depositing a superhydrophobic coating dispersion described herein on a substrate. In some embodiments, the superhydrophobic coating dispersion is disposed upon a first surface of the substrate, and the substrate further comprises a second surface opposite the first surface, and wherein an adhesive is disposed upon the second surface.

Some embodiments include a coated substrate, wherein the substrate has been coated with a superhydrophobic coating dispersion described herein; and wherein at least a portion of the microbeads extend above the surface of the organosilane, providing a micro-contoured surface morphology sufficient to provide a superhydrophobic effect.

Some embodiments include a coating having an exterior coating surface, for application to a substrate. In some embodiments, the coating is transparent. In some embodiments, the coating can comprise 10 to 75 wt % or 10-80 wt % organosilane. In some embodiments the organosilane can be a low surface energy polymer. In some embodiments, the coating can comprise 20 to 60 wt % inorganic nanofibers disposed within the organosilane. In some embodiments, the coating can comprise 0.5 to 40 wt % microbeads. In some embodiments, the plurality of microbeads can be disposed on the coating surface, wherein at least a portion of at least one microbead extends above the surface of the coating matrix, providing a micro-contoured surface morphology sufficient to provide a superhydrophobic effect. In some embodiments, the transparent coating may have a total transparency of greater than 75%. In some embodiments, the coating may have a water sliding angle of 10° or less, 8° or less, 6° or less, or 4° or less. In some embodiments, the organosilane may be a C₁ to C₈ alkoxysilane. In some embodiments, the alkylsilane may be tetraethoxysilane. In some embodiments, the organosilane may be a fluorinated alkylsilane. In some embodiments, the organosilane may be polydimethylsiloxane (PDMS). In some embodiments, the inorganic nanofibers may comprise a metal oxide. In some embodiments, the metal oxide may be alumina. In some aspects, the metal oxide may be Al₂O₃. In some embodiments, the microbead may comprise a silicone microbead. In some embodiments, the microbead may comprise a fluorinated polymer. In some embodiments, the nanofibers may comprise at least one hydroxyl functional group. In some embodiments, the at least one hydroxyl functional group of the nanofibers may be covalently coupled to the organosilane. In some embodiments, the covalent coupling of the hydroxyl groups to the alkylsilane may be by the application of chemical vapor deposition of a fluorinated silane to the nanofiber surface. In some aspects, the polymer may comprise at least one hydroxyl functional group. In some embodiments, the polymer may comprise PDMS-OH. In some embodiments, the coating has a water contact angle of at least 140°. In some embodiments, the coating has a water slide angle of less than or equal to 10°.

Some embodiments include a method for making a coating, the method can comprise mixing metal oxide nanofibers, silicone microbeads, an alkylsilane polymer, and a polar solvent to get a uniform dispersion; applying the uniform dispersion to a substrate; and heating the applied dispersion to evaporate the polar solvent. In some embodiments, the polar solvent is at least 198 proof ethanol, e.g., 200 proof ethanol. In another embodiment, the method can further comprise a second heating of the dried applied dispersion under a vacuum to covalently crosslink the polymer hydroxyl functional groups to the nanofibers. In some embodiments, the added amount of metal oxide nanofibers can be between 30 wt % to 60 wt %. In some embodiments, the added amount of silicone microbeads can be between 5 wt % to 30 wt %. In some embodiments, the alkyl silane can be tetraethyl orthosilane. In some embodiments, the solvent can be a non-polar solvent having a purity above 99%. In some embodiments, the first heating is at a temperature of less than 90° C. In some embodiments, the second [CVD treating] heating can be performed at about 100° to about 140° C. for about 1 to about 12 hours. In some embodiments, a transparent coating made in accordance to above described methods.

Some embodiments include a method of surface treatment comprising applying a composite described herein to a surface in need of treatment.

### BRIEF DESCRIPTION OF THE DRAWINGS

FIG. 1 is a drawing depiction of a possible embodiment of a coating with a micro/nano rough surface.

FIG. 2 is a drawing depiction of a possible embodiment of a coating with a micro/nano rough surface.

FIG. 3 is an SEM photograph depicting a micro/nano rough surface of an embodiment (EX-1).

FIG. 4 is an SEM photograph depicting a micro/nano rough surface of an embodiment (EX-1) in a different scale.

FIG. 5 is a depiction and corresponding SEM photograph comparing micro/nano roughness on the surface of a possible embodiment.

FIG. 6 is a depiction and corresponding SEM photograph comparing micro/nano roughness on the surface of a possible embodiment.

FIG. 7 is a graph representing the 1/K value over temperature of one possible embodiment.

FIG. 8 is a graph representing the 1/K value over temperature of one possible embodiment.

FIG. 9. is a representation of the snow sliding test.

FIG. 10. is a graph representing the transmittance of the example of a possible embodiment.

FIG. 11. Is a graphic representation of the % Transmittance (T %) over thickness of a possible embodiment.

### DETAILED DESCRIPTION

The present disclosure relates to hydrophobic, superhydrophobic, and/or snowphobic composites that can be useful as coatings for anti-ice and anti-snow applications. “Hydrophobic composites” and “superhydrophobic composites” include composites that are hydrophobic, highly hydrophobic, or water repellant. Water repellency may be measured by the contact angle of a droplet of water on a surface. If the water contact angle is at least 90 degrees (or 90°) it is said to be hydrophobic. If the water contact angle is at least 150° it is said to be superhydrophobic.

“Bulk composites” are composites, coatings, paints, etc., that exhibit hydrophobic, superhydrophobic and/or snowphobic properties throughout the composite, coating, paint, etc., instead of only on the surface. This may provide an advantage in that if the surface is eroded or ablated, the remaining surface retains its hydrophobic, superhydrophobic and/or snowphobic properties. Thus, some bulk composites described herein are damage tolerant such that the phobic properties are retained after being eroded.

One way to determine whether a composite has bulk hydrophobicity and/or bulk superhydrophobicity is by removing the surface and some amount of the underlying material by abrasion and measuring the contact angle after abrasion. For example, the contact angle may be measured after 5-8 μm, 5-6 μm, 5 μm, 6 μm, 6-7 μm, 7 μm, 7-8 μm, or 8 μm of the material from the surface has been removed by abrasion. In some embodiments, the composite retains or gains its superhydrophobic properties (e.g., contact angle) after abrasion.

“Snowphobic” or snow phobicity as used herein refers to composites wherein snow, with water content in the range of 0-20 wt % and snow loading of 1.0 g/cm², will slide off a composite treated substrate with an inclining angle of 30° or greater and within 1-3 minutes of the snow accumulation. Not only will the snow slide off the treated substrate, but the treated substrate will at maximum experience less than 20% area coverage with snow prior to the snow sliding.

As used herein the term “compatibilize” has the meaning known by those of ordinary skill in the art. Compatibilization is related to a substance, that when added to an immiscible blend of polymers, increases the polymer blend's stability by creating interactions between the two immiscible polymers.

Some embodiments include composites useful in the repellency of water, snow and/or ice. In some embodiments, the composite can be a coating. In some embodiments, the coating can have a thickness in a range of about 0.5 μm to about 1000 μm, or about 20 μm, about 25 μm, about 30 μm, about 35 μm about 46 μm, about 79 μm, about 106 μm, or any thickness in a range bounded by any of these values.

Some embodiments include a coating for application to a substrate. In some aspects, the coating can comprise a matrix, wherein the matrix can comprise an organosilane. In some examples, the organosilane can be a low surface energy polymer. In some embodiments, the organosilane can be a hydrolyzed alkylsilane. In some embodiments, the organosilane can be a hydrolyzed perfluoroalkylsilane. In some aspects, the organosilane matrix may comprise about 10 wt % to about 80 wt % of the total weight of the coating. In some embodiments, the coating can comprise a plurality of inorganic nanofibers disposed within the matrix, wherein the inorganic nanofibers can be dispersed throughout the matrix to reduce the refractive effects of the nanofibers. In some embodiments, the coating may comprise a plurality of inorganic microbeads which may impart a micro-contoured surface morphology to the matrix surface, wherein at least a portion of at least one microbead extends above the matrix surface of the coating, e.g. the surface formed by the matrix material. In some embodiments, the organosilane may be a C₁ to C₈ alkylsilane (e.g. having 1, 2, 3, or 4 alkyl groups, which are independently methyl, ethyl, propyl, isopropyl, C4 alkyl, C5 alkyl, C7 alkyl, C8 alkyl, etc.) or a C₁₋₈ fluoroalkylsilane (e.g. having 1, 2, 3, or 4 fluoroalkyl groups, which are independently C1 fluoroalkyl, C2 fluoroalkyl, C3 fluoroalkyl, C4 fluoroalkyl, C5 fluoroalkyl, C7 fluoroalkyl, C8 fluoroalkyl, etc.). In some embodiments, the alkylsilane may be tetraethoxysilane. In some examples, the fluoroalkylsilane may be 1H,1H,2H,2H-perfluorooctyltriethoxysilane. In some embodiments, the organosilane may be PDMS. In some embodiments, composite may have a nanofiber wt % between 30 wt % and 60 wt %. In some embodiments, the inorganic nanofibers may comprise a metal oxide. In some embodiments, the metal oxide may be alumina. In some aspects, the inorganic nanofibers may be hydrophobized. In some embodiments, the inorganic nanofibers may be coated with 1H,1H,2H,2H-perfluorooctyltriethoxysilane. In other embodiments, the inorganic nanofibers may be coated with vinyltrimethoxysilane. In some embodiments, the composite may have a microbead wt % between 0.5 wt % and 40 wt %. In some embodiments, the microbead may comprise a silicone microbead. In some embodiments, the microbead may comprise a fluorinated polymer. In some examples, the coating may have a haze of less than 10%. In some aspects, the coating may be transparent. In some embodiments, the coating can have a total transparency of greater than 75%. In some embodiments, the coating can have a contact angle of at least 140°.

Some embodiments include a method for making a coating. In some aspects, the method for making a coating comprises mixing metal oxide nanofibers, silicone microbeads, an organosilane polymer, and a polar solvent to prepare a uniform dispersion. In some examples, the method for making a coating comprises mixing metal oxide nanofibers, silicone microbeads, a hydrolyzed TEOS, and a polar solvent to prepare a uniform dispersion. In other embodiments, the method for making a coating comprises mixing metal oxide nanofibers, silicone microbeads, hydrolyzed 1H,1H,2H,2H-perfluorooctyltriethoxysilane, and a polar solvent to prepare a uniform dispersion. In some embodiments, the polar solvent is ethanol. In some embodiments, the ethanol may be greater than 95% pure (190 proof), 97% (194 proof), 98% (196 proof), 99% (198 proof), 99.5% (199 proof) pure. In some embodiments, the polar solvent may be 100% pure (200 proof). In some embodiments, the method comprises applying the uniform dispersion to a substrate. In some embodiments, the added amount of metal oxide nanofibers can be between 20 wt % to 60 wt %. In some embodiments, the added amount of silicone microbeads can be between 5 wt % to 30 wt %. In some embodiments, the organosilane can be tetraethyl orthosilicate or tetraethoxysilane (TEOS), or 1H,1H,2H,2H-perfluorooctyltriethoxysilane (FOS). In some embodiments, the solvent can be a solvent having a purity above 99% (198 proof). In some embodiments, a transparent coating may be made in accordance to the above described methods. In some embodiments, the transparent superhydrophobic coating may have a total transparency of greater than 75%. In some embodiments, the transparent superhydrophobic coating may have a contact angle of at least 140°.

In some embodiments, the composite may be in any suitable form, such as a solid, e.g., a composite solid or a homogeneous solid. For example, various components of the composite may be mixed such that they form a substantially uniform mixture. In some aspects, the composite may be a composite liquid dispersion. In some embodiments, components of the composite may be crosslinked, and may, for example, form a matrix. In some embodiments, some of the components may be loaded into the matrix. In some embodiments, the composite can form a coating, e.g., a paint, an epoxy, powder coating, etc. In some aspects, the composite may be provided as a substantially uniform liquid dispersion to be used as a paint or a coating. In some embodiments, the substantially uniform liquid dispersion may be applied to a substrate, such as an object or surface in need of a hydrophobic, superhydrophobic, or snowphobic coating. In some aspects, substrate may include a road, a bridge, a building, a roof, a roadsign, a window, a vehicle, the interior of a refrigerator or a freezer, a driveway, a sidewalk, a walkway or any other suitable substrate.

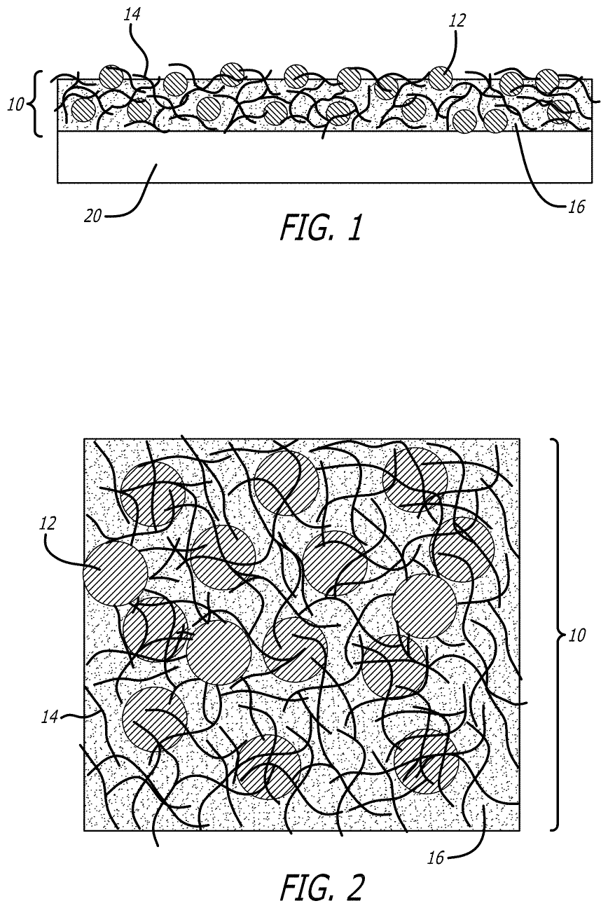

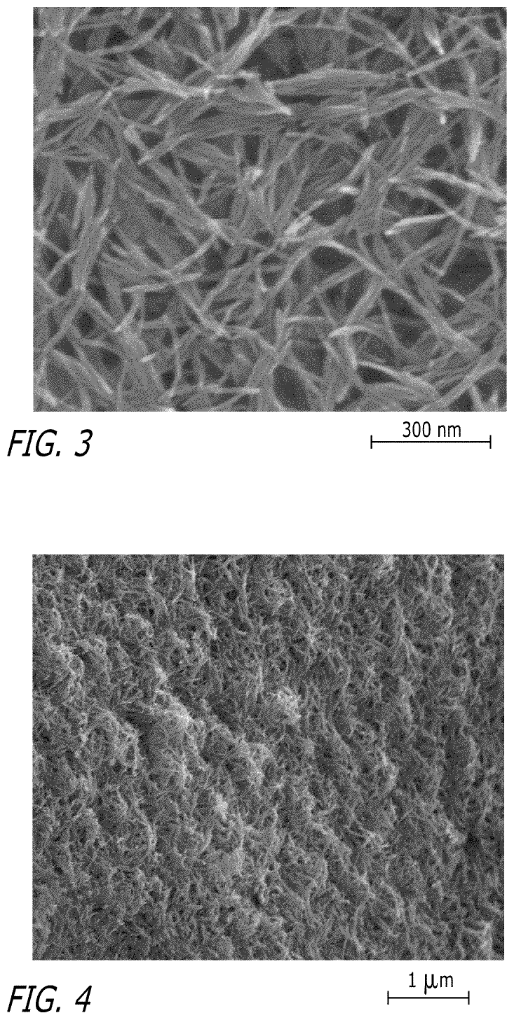

FIGS. 1 and 2 are diagrams of a cross section of an embodiment of the coating described herein. In some embodiments, the coating 10 may include a plurality of microbeads or microbeads 12 and a plurality of nanofibers 14 disposed within a polymer matrix 16. The coating 10 can have an exterior surface exposed to the environment, wherein at least one of microbeads can have a portion extending above the surface of the coating 10. It is believed that the coating 10 may be disposed upon a substrate 20 to provide a hydrophobic surface thereupon.

Polymer Matrix Some embodiments include a polymer matrix having a matrix surface. In some examples, the polymer matrix is referred to as a binder. In some embodiments, the matrix can comprise a low surface energy polymer, e.g., may have a surface energy of less than or equal to 22 γₛ/mJ m⁻².

In some embodiments, polymer matrix may comprise an organosilane group, such as an alkylsilane, an alkoxysilane, a fluoroalkylsilane including a perfluoroalkylsilane, a fluoroalkylsilane, a fluoroalkylalkoxysilane, or a combination thereof. In some embodiments, the organosilane may comprise a compound based on a polyalkyl orthosilicate, e.g., tetraethyl orthosilicate (TEOS). In some embodiments, the organosilane may be a hydrolyzed TEOS, a fluorinated TEOS, or a hydrolyzed fluorinated TEOS. In some embodiments, the hydrolyzed TEOS may be a hydrolyzed silica sol from TEOS. In some embodiments, the fluorinated TEOS may be achieved by chemical vapor deposition (CVD) processing with fluoroalkylalkoxysilane. In some embodiments, the fluoroalkylalkoxysilane may comprise a compound based on 1H,1H,2H,2H-perfluorooctyltriethoxysilane (FOS). In some embodiments, the fluoroalkylalkoxysilane may comprise a hydrolyzed FOS. In some embodiments, the hydrolyzed FOS may be a hydrolyzed silica sol from FOS. In some embodiments, the organosilane may be a combination of hydrolyzed TEOS and hydrolyzed FOS. In some embodiments, the organosilane may comprise PDMS, which is an example of a low surface energy polymer. In some embodiments, the organosilane may comprise hydroxyl-terminated PDMS (PDMS-OH). In some examples, the organosilane may be a combination of hydrolyzed TEOS and PDMS-OH. In some aspects, the organosilane may be a combination of hydrolyzed FOS and hydrolyzed PDMS-OH. In some embodiments, the organosilane may be a combination of hydrolyzed TEOS, hydrolyzed FOS, and PDMS-OH. In some embodiments, the organosilane can be prepared by mixing the hydrolyzed TEOS, hydrolyzed FOS, and/or PDMS-OH in a polar solvent. In some embodiments, the organosilane can be prepared chemical vapor deposition of hydrolyzed TEOS, hydrolyzed FOS, and/or PDMS-OH.

The matrix may be present in any suitable amount such as, about 10-80 wt %, about 10-20 wt %, about 20-30 wt %, about 30-40 wt %, about 40-45 wt %, about 45-50 wt %, about 50-55 wt %, about 55-60 wt %, about 60-65 wt %, about 65-70 wt %, or about 70-80 wt %, based upon the total weight of the coating.

In some embodiments, the polymer matrix can have a contact angle of greater than 100°, e.g., at least 160°. In some aspects, the polymer matrix can have a contact angle of at least 150°, at least 155°, at least 158°, at least 159°, or at least 160°.

### Microbeads

The composite can comprise a plurality of microspheres, microbeads, or microparticles. It is believed that microbeads used to create micro-roughness in the coatings may cause decreasing total transmittance through the coating due to Mie scattering. As a result, it is believed that increasing the microbeads' loading in the coating could dramatically reduce the transmittance of coating. In some embodiments, the microbeads' weight percentage in the overall coating can be between 0.5 wt % to 40 wt %. In some embodiments, the microbead weight percentage in the overall coating can be 0.5-2 wt %, 2-4 wt %, 4-5 wt %, 4-6 wt %, 6-8 wt %, 8-10 wt %, 10-15 wt %, 15-20 wt %, 20-30 wt %, 30-40 wt %, 2 wt %, 4 wt %, 5 wt % to 7 wt %, 10 wt %, 17 wt %, 30 wt %, and or any wt % in a range bounded by any of these values. In some embodiments, the microbeads size can be 1 micrometer to 5 micrometers, e.g., 2 micrometers. It is believed that the size of the microbeads can have an influence on total transmittance of coating. Microbeads in the above described size range can comprise silicone resin, silicone rubber, hybrid silicone, PMMA, polyethylene, polypropylene, polystyrene, glass, silica etc.

The microbeads may have any size associated with a spherical or ovoidal shape. For example, a microbead may have a size, average size, or median size such as a radius or diameter of the sphere that is about 0.1 μm to about 100 μm, about 0.1-0.5 μm, about 0.5-1 μm, about 1-2 μm, about 2-3 μm, about 3-4 μm, about 4-5 μm, about 5-6 μm, about 6-7 μm, about 7-8 μm, about 8-9 μm, about 9-10 μm, about 10-20 μm, about 20-30 μm, about 30-40 μm, about 40-50 μm, about 50-60 μm, about 60-70 μm, about 70-80 μm, about 80-90 μm, about 90-100 μm, about 30-70 μm, about 35-40 μm, about 40-45 μm, about 45-50 μm, about 50-55 μm, about 55-60 μm, about 60-65 μm, about 65-70 μm, or any size such as a radius, a diameter, in a range bounded by any of these ranges.

As used herein, the terms “radius” or “diameter” can be applied to microbeads that are not spherical or cylindrical. For an elongated microbead, where the aspect ratio (i.e., length/width or length/diameter) is important, the “radius” or “diameter” is the radius or diameter of a cylinder having the same length and volume as the microbead. For non-elongated microbeads, the “radius” or “diameter” is the radius or diameter of a sphere having the same volume as the microbead.

In some embodiments, the microbeads may comprise a plurality of hydrophobic nanoparticles disposed upon the first core surface of the microbeads. In some embodiments, the hydrophobic nanoparticles may encapsulate a portion of the circumferential surface of the microbead core. In some embodiments, at least some of the hydrophobic particles extend outward from the surface of the microsphere. In some embodiments, the plurality of microbeads may define cavities therebetween. In some embodiments, a portion of the hydrophobic encapsulated microbeads dispersed within the first surface of the matrix may form a micro/nano rough coating on the matrix surface.

### Nanofibers

Some embodiments include a plurality of nanofibers. In some embodiments, the nanofibers can comprise a metal oxide. In some embodiments, the metal oxide can comprise aluminum oxide, silicon oxide, titanium oxide, magnesium oxide, zinc oxide, magnesium aluminum oxide, lanthanum phosphate phyllosilicate, palygorskite, halloysite, sepiolite, mullite, montmorillonite, kaolinite, chitin, chitosan cellulose, lignin, or combinations thereof. In an embodiment, the metal oxide can comprise aluminum oxide.

In some embodiments, the nanofibers are surface modified nanofibers. In some aspects, the surface of the nanofibers is modified with a hydrophobic coating. Some embodiments include a metal oxide as the nanofiber. In some examples, the nanofibers are Al₂O₃ nanofibers. In some embodiments, the Al₂O₃ nanofibers are surface modified or coated with 1H,1H,2H,2H-perfluorooctyltriethoxysilane (FOS). In some embodiments, the Al₂O₃ nanofibers are surface modified or coated with vinyltrimethoxysilane. In some embodiments, the Al₂O₃ nanofibers may be surface modified or coated with FOS and vinyltrimethoxysilane.

Some embodiments include a metal oxide (e.g., Al₂O₃) as a nanofiber. The nanofiber may be an elongated nanoparticle. In some embodiments, the nanofibers can have a length of about 1 μm to about 3 μm and a width or diameter of about 30 nm to about 70 nm. It is believed that the nanofibers may have an aspect ratio (i.e., length/width or length/diameter) of about 10 to about 100, about 5-10, about 5-25, about 10-30, about 15-35, about 20-40, about 25-45, about 30-50, about 35-55, about 40-60, about 45-65, about 50-70, about 55-75, about 60-80, about 65-85, about 70-90, about 75-95, about 80-100, or any aspect ratio in a range bounded by any of these values.

In some embodiments, the nanofibers may be about 0-60 wt %, about 20-60 wt %, about 5-45 wt %, about 0.1-20 wt %, about 10-40 wt %, about 15-35 wt %, about 20-30 wt %, about 20-25 wt %, about 20-25 wt %, about 25-30 wt %, about 30-35 wt %, about 25-35 wt %, about 35-40 wt %, about 40-45 wt %, about 45-50 wt %, about 35-50 wt %, or about 50-60 wt % of the total weight of the composite, or any weight percentage in a range bounded by any of these values. Of particular interest are any of the above ranges that encompass one or more of the following weight percentages: about 40 wt %, about 41 wt %, about 42 wt %, about 43 wt %, about 44 wt %, and about 45 wt %.

In some embodiments, the nanofibers can have a concentrated distribution within the composite. The distribution of the nanofibers is thought to result in a composite having exposed surfaces that define a nano-structure roughness with a scale commensurate with the dimensions of the nanofibers; even after abrasion of the initial surface. It is further thought that the nanostructure-scale roughness when combined with the hydrophobic character of the other materials in the composite result in a hydrophobic, superhydrophobic, and/or snowphobic composite that retains its hydrophobicity, superhydrophobicity, and/or snowphobicity even after the initial surface is eroded away.

In some embodiments, the composite can comprise a hydrophobized hydrophilic material. In some embodiments, the hydrophobized hydrophilic material can be metal oxide nanofibers, clay nanofibers, and/or a bio-based nanofiber.

The nanofibers can be fabricated by sol-gel method, vapor reaction method, hydro-thermal method, deposition method, physical crumbling method, mechanical ball polishing method, chemical vapor deposition method, micro-emulsion method, electro-chemistry method, or any other suitable method.

### Micro/Nano Rough Surface

In some embodiments, the low surface energy polymer can be combined or mixed to form a polymer matrix, 16, as shown in FIGS. 1 and/or 2. In some embodiments, a substantial amount of the hydrophobic microbeads, 12, as shown in FIGS. 1 and 2, can be dispersed within the polymer matrix. In some embodiments, a sufficient amount of the hydrophobic microbeads can partially protrude through the first's surface of the matrix creating a micro/nano roughness thereon, as shown if FIG. 1. The composite can also contain other components, such as nanofibers 14.

The nano roughness may have any size associated with a nanofiber. The nanoparticle may comprise any suitable materials, for example but not limited to a nanorod, nanowire, nanotube, nanofiber, etc. The nanoparticle may have a size, average size, or median size such as a radius or diameter, of the particle that is about 10 nm to about 500 nm, about 10-20 nm, about 10-30 nm, about 20-30 nm, about 30-40 nm, about 40-50 nm, about 50-60 nm, about 60-70 nm, about 70-80 nm, about 80-90 nm, about 90-100 nm, about 10-100 nm, about 100-110 nm, about 100-200 nm, about 150-250 nm, about 200-300 nm, about 250-350 nm, about 300-400 nm, about 350-450 nm, about 400-500 nm, or any size, such as a radius, a diameter, in a range bounded by any of these values.

### Substrate

Any suitable material may be used for the substrate, such as substrate 20. In some examples, a substrate, may be prepared from a transparent material. In some embodiments, the substrate may comprise soda-lime glass. In certain aspects, the substrate material may comprise polycarbonate, polyesters (e.g., polyethylene terephthalate (PET)), polytrimethylene terephthalate (PTT), polybutylene terephthalate (PBT), polyethylene naphthalate (PEN), polybutylene naphthalate (PBN), polyolefin, cyclic polyolefin, polyimide, polysulfone, polyether sulfone and the like. In some embodiments, the substrate is a transparent substrate. In some embodiments, the substrate is a flexible film, wherein the film thickness is preferably in the range of 25-500 μm. In some embodiments, the substrate can be a surface of an object. In some examples, the object is treated to impart hydrophobic, superhydrophobic, and/or snowphobic characteristics. In some embodiments, the object may be an interior freezer surface, or a road, or any other surface in need of hydrophobic, superhydrophobic, and/or snowphobic characteristics.

### Method

Some embodiments include a method of making a coating. The method can comprise the steps of: (1) adding surface modified nanofibers into a solvent and mix until the surface modified nanofibers are uniformly dispersed within the solvent; (2) adding polymers and/or binders to the surface modified nanoparticle dispersant and mix; (3) adding silicone microbeads to the surface modified nanofiber dispersant and mix to create a slurry; (4) coat the slurry onto a substrate; (5) bake the coating at a temperature of between about 40° C. to 140° C., or about 100° C., or about 120° C., to remove the solvent; and (6) optionally subjecting the cured coating to a post-curing chemical vapor deposition (CVD) or chemical liquid deposition (CLD) with perfluoroalkylsilane to increase surface hydrophobicity.

In some embodiments, a method of surface treatment can comprise applying the aforedescribed surface coating to a surface in need thereof.

The surface treatment coating may be in the form of a solid layer on a surface where prevention of fouling, ice and/or snow accumulation is required. In some embodiments, the coating is a solid layer with a thickness of about 0.5-1 μm, about 1-2 μm, about 2-5 μm, about 5-10 μm, about 10-16 μm, about 16-20 μm, about 18-22 μm, about 20-24 μm, about 22-26 μm, about 24-28 μm, about 26-30 μm, about 28-32 μm, about 30-34 μm, about 32-36 μm, about 34-38 μm, about 36-40 μm, about 38-42 μm, about 40-44 μm, about 42-46 μm, about 44-48 μm, about 46-50 μm, about 45-52 μm, about 50-57 μm, about 55-62 μm, about 60-67 μm, about 65-72 μm, about 70-77 μm, about 75-82 μm, about 80-87 μm, about 85-92 μm, about 90-97 μm, about 95-102 μm, about 100-107 μm, about 105-112 μm, about 110-117 μm, about 115-122 μm, about 120-127 μm, or about 125-132 μm, or any thickness in a range bounded by any of these values. Of particular interest are any of the above ranges that encompass one or more of the following thicknesses: about 22 μm, about 23 μm, about 25 μm, about 26 μm, about 27 μm, about 30 μm, about 33 μm, about 35 μm, about 46 μm, about 50 μm, about 51 μm, about 79 μm, about 101 μm, about 102 μm, and about 106 μm.

In some embodiments the treating step can also comprise applying the coating mixture on the untreated surface. Applying the coating mixture can be done by any suitable method, such as blade coating, spin coating, die coating, physical vapor deposition, chemical vapor deposition, spray coating, ink jet coating, roller coating, etc. In some embodiments, the coating step may be repeated until the desired thickness of coating is achieved. In some methods, applying may be done such that a contiguous layer is formed on the surface to be protected.

In some embodiments, the wet coating may have a thickness of about 1-50 μm, about 10-30 μm, about 20-30 μm, about 30-50 μm, about 50-150 μm, about 100-200 μm, about 150-250 μm, about 200-300 μm, about 260-310 μm, about 280-330 μm, about 300-350 μm, about 320-370 μm, about 340-390 μm, about 360-410 μm, about 380-430 μm, about 400-450 μm, about 420-470 μm, about 400-600 μm, about 500-700 μm, or about 600-800 μm or any thickness in a range bounded by any of these values. Of particular interest are any of the above ranges that encompass one or more of the following thicknesses: about 25 μm, about 300 μm, about 350 μm, about 380 μm, and about 790 μm.

In some embodiments, treating can further comprise curing the coating by heating the coating to a temperature and time sufficient to completely evaporate the solvent. In some embodiments, the step of curing can be done at a temperature of about 40° C. to about 150° C., or about 120° C., for about 30 minutes to 3 hours, or about 1-2 hours, until the solvent is completely evaporated. In some embodiments, a coating by the process described above can be provided. The result can be a treated surface that can be resistant to water or ice even after facing a harsh environment where some of the coating has been eroded.

### EMBODIMENTS

Embodiment 1 A transparent coating having an exterior surface, for application to a substrate, comprising:

65 to 10 wt % organosilane, wherein the organosilane is a low surface energy polymer;

30 to 60 wt % inorganic nanofibers disposed within the organosilane, and

5 to 30 wt % microbeads disposed on the coating surface, wherein at least a portion of at least one microbead extends above the matrix surface of the coating providing a micro-contoured surface morphology sufficient to provide a superhydrophobic effect.

Embodiment 2 The transparent superhydrophobic coating of embodiment 1, wherein the coating has a water sliding angle of less than or equal to 10°.

Embodiment 3 The transparent superhydrophobic coating of embodiment 1, wherein the organosilane is an C₁ to C₈ alkylsilane.

Embodiment 4 The transparent superhydrophobic coating of embodiment 1, wherein the alkylsilane is tetraethoxysilane.

Embodiment 5 The transparent superhydrophobic coating of embodiment 1, wherein the inorganic nanofibers comprise a metal oxide.

Embodiment 6 The transparent superhydrophobic coating of embodiment 1, wherein the metal oxide is alumina.

Embodiment 7 The transparent superhydrophobic coating of embodiment 1, wherein the microbead comprises a silicone microbead.

Embodiment 8 The transparent superhydrophobic coating of embodiment 1, wherein the microbead comprises a fluorinated polymer.

Embodiment 9 The transparent superhydrophobic coating of embodiment 1, wherein the nanofibers comprise at least one hydroxyl functional group, wherein the at least one hydroxyl functional group of the nanofibers is covalently coupled to the alkyl silane.

Embodiment 10 The transparent superhydrophobic coating of embodiment 1, wherein the covalent coupling of the hydroxyl groups to the alkyl silane is by the application of chemical vapor deposition [CVD] to the nanofiber surface.

Embodiment 11 The transparent superhydrophobic coating of embodiment 1, wherein the coating has a contact angle of at least 140°.

Embodiment 12 A method for making a coating comprising:

Mixing metal oxide nanofibers, silicone microbeads, an alkyl silane polymer, the alkyl and a polar solvent to get a uniform dispersion;

Applying the uniform dispersion to a substrate;

First heating the applied dispersion to evaporate the polar solvent;

A second heating the dried applied dispersion under a vacuum to covalently crosslink the polymer hydroxyl functional groups to the nanofibers.

Embodiment 13 The method of Embodiment 11, wherein the added amount of metal oxide nanofibers is between 30 wt % to 60 wt %.

Embodiment 14 The method of Embodiment 11, wherein the added amount of silicone microbeads is between 5 wt % to 30 wt %.

Embodiment 15 The method of Embodiment 11, wherein the alkyl silane is tetramethyl orthosilane.

Embodiment 16 The method of Embodiment 11, wherein the solvent is a polar solvent having a purity above 99% (198 proof).

Embodiment 17 The method of Embodiment 11, wherein the first heating is at a temperature of less than 90° C.

Embodiment 18 The method of Embodiment 11, wherein the second [CVD treating] heating is performed at about 100° to about 140° C. for about 1 to about 12 hours.

Embodiment 19 A transparent coating made in accordance to embodiments 11-17.

### EXAMPLES

It has been discovered that embodiments of the composite described herein exhibit bulk performance. These benefits are further demonstrated by the following examples, which are intended to be illustrative of the disclosure, but are not intended to limit the scope or underlying principles in any way.

### Example 1.1: Preparation of the Aluminum Oxide Nanofibers Dispersion

### Preparation of the Hydrophobic Nanofibers

4.0 g of Al₂O₃ nanofiber (NAFEN™, ANT Technology, UK) was added onto a standard stainless-steel sieve (D76.2 mm, opening 250 μm, DUAL MFG Co. USA). 2 mL of tridecafluoro-1,1,2,2-tetrahydrooctyl)triethoxysilane (also referred to as “FOS” and “POTS,” obtained from Gelest Inc, product number SIT 8175.0, CAS number 51851-37-7) was added to a 400 mL glass jar with an inner diameter of 80 mm, a sieve was then set into a glass jar. The sieve was then covered with a glass petri dish and then the glass jar with sieve was placed into a vacuum glass desiccator (VWR diameter 215 mm). The desiccator was first kept under vacuum with the valve fully open for 5 min, the valve was then closed, and the desiccator transferred into a convection oven (VWR, Radnor, Pa., USA). The temperature of the oven was raised at a ramp of 5° C. per min up to 120° C. and kept at that temperature for 4 hours, then cooled down to ambient temperature to get a surface modified Al₂O₃ nanofiber.

### Nanofiber Dispersion

A hydrophobic Al₂O₃ nanofiber dispersion (2.5 wt %) was prepared by mixing 16 g absolute ethanol (KEPTEC, Proof 200) and 0.4 g of the aforementioned Al₂O₃ hydrophobic nanofibers added to a 20 mL glass jar during sonication with the probe set on the sonic dismembrator setting at 15 W. Sonicate for 1 hour (Fisherbrand™ 120). A stable colloidal Al₂O₃ nanofiber dispersion can be keep for up to 1 month in a static setting.

Preparation of Hydrolyzed TEOS, Al₂O₃ Nanofibers and Silicone Microbeads (EX-1)

A hydrolyzed TEOS binder solution was prepared from 12 mL absolute ethanol (KEPTEC, Proof 200) and 15 mL tetraethyl orthosilicate (TEOS 98%, Aldrich) added to a 100 mL glass jar and agitated with Teflon coated stirrer bar for 30 min. Next, 2.4 mL of Milli-Q® water was added dropwise while maintaining agitation for 30 min. After the addition of the Milli-Q® water the pH was adjusted by adding about 4 mL 0.1M HCl aqueous solution dropwise until the pH of solution was in the pH range of 2.0 to 3.0. The resulting solution was agitated for more than 24 hours at room temperature.

Next, 18 mL of the hydrophobic Al₂O₃ nanofiber dispersion prepared above and 9 mL of hydrolyzed TEOS binder were added together in a 100 mL polyethylene jar with lid and mixed with centrifuge mixer (THINKY 3000) at 2000 rpm for 2 min. Separately, 1.125 g of silicone microbeads (KMP-605) with average diameter of 2 μm and particle size distribution of 0.7-5 μm was dispersed in 10 mL absolute ethanol (200 proof) in 20 mL glass vial in an ultrasonic cleaner for 1 hour. The silicone microbeads dispersion was added to the dispersion of Al₂O₃ nanofiber plus hydrolyzed TEOS binder and mixed with centrifuge mixer again at 2000 rpm for 1 min to get coating dispersion mixture.

The transparent coating prepared by applying the mixture of hydrolyzed TEOS, alumina nanofibers and silicone microbeads to a PET substrate (Hostaphan® 4507, Mitsubishi Polyester Film, Inc., USA) to create a hydrophobic surface with a water contact angle about 140 degrees.

### Example 1.2: Post-CVD-Treatment of Transparent Hydrophobic Coatings

The transparent coating prepared by applying a mixture of hydrolyzed TEOS, hydrophobic alumina nanofibers and silicone microbeads to a substrate have a hydrophobic surface with water contact angles of about 140°. To make a superhydrophobic surface coating with a water contact angle greater than 160° and water sliding angle smaller than 5°, treatment of the cured coatings with perfluoroalkylsilane is implemented by chemical vapor deposition (CVD). After CVD treatment, the coatings showed water contact angle greater than 160 degrees and water sliding angle smaller than 5 degrees while there is no observable visual change in transmittance and haze.

The coatings, on a PET substrate (4 inches by 8 inches), were fixed on a glass substrate, with the coating side facing out. The coated glass substrate was placed in a thin layer chromatography glass chamber (10″×10″×3″), set vertically against the wall of chamber. 1 ml of (FOS), 1H,1H,2H,2H-perfluorooctyltriethoxysilane (also known as “POTS,” C₁₄H₁₉F₁₃O₃Si; Gelest Inc. Cas No: 51851-37-7), and 0.5 mL Milli-Q® water were added to 20 mL glass vials respectively and placed on the bottom of glass chamber as CVD sources. The chamber, sealed and locked with a silicone rubber gasket and glass lid, was then placed in a convection oven (Symphony™, VWR) and heated to 120° C. at a rate of 5° C./min. Once 120° C. was achieved, the temperature was maintained for 4 hours and then cooled down to ambient temperature. (Ex-1).

In a similar manner, the mixture of hydrolyzed TEOS, hydrophobic alumina nanofibers and silicone microbeads may be applied directly to the glass substrate (i.e., without the PET substrate), and afterward CVD treated, to prepare a hydrophobic glass surface.

### Example 2: Preparation of Hybrid Binder by Co-Condensation of Perfluoroalkylsilane and TEOS

A hydrolyzed FOS solution was prepared by the following procedure. 9 mL of FOS (1H,1H,2H,2H-perfluorooctyltriethoxysilane, CAS51851-37-7, 99% Gelest Inc.) and 15 mL of absolute ethanol (Koptek 200 proof pure ethanol) were combined in a 50 mL glass jar. The mixture was agitated with magnetic stirring bar for 30 min and then 1 mL of 0.01M HCl was added. The solution was kept agitated for 24 hours to afford a hydrolyzed FOS solution.

A hydrolyzed TEOS binder solution was prepared by the following procedure. 12 mL absolute ethanol (KEPTEC, Proof 200) and 15 mL tetraethyl orthosilicate (98%, Aldrich) were combined in a 100 mL glass jar and agitated with Teflon coated stirrer bar for 30 min. 2.4 mL Milli-Q® water was added dropwise and the agitation was maintained for 30 min. About 4 mL 0.1M HCl aqueous solution was added dropwise to bring the pH of solution to the range 2.0 to 3.0. The resulting solution was agitated for more than 24 hours at room temperature to afford a hydrolyzed TEOS binder solution.

A Hybrid FOS/TEOS binder was prepared by mixing 0.4 g of the above-described hydrolyzed FOS and 5 g of the above-described hydrolyzed TEOS under agitation for 16 hours at room temperature through a co-condensation reaction. Hybrid mixtures having different weight ratios of TEOS/FOS were also prepared as shown in column 2 of Table 1 below.

Coatings comprising Al₂O₃ nanofiber modified with perfluoroalkylsilane, silicone microbeads (KMP-605, Shin-Etsu Silicones, Japan) and hybrid TEOS/FOS binder in Table 1 below, exhibited a superhydrophobic surface without a CVD treatment with perfluoroalkylsilane.

TABLE 1

| | | TEOS/ | | | | |
|---|---|---|---|---|---|---|
| | TEOS/ | FOS | Al₂O₃ NF | beads | | |
| Sample | FOS | (wt % | (wt % | (wt % | | |
| ID | (w/w) | of total) | of total) | of total) | WCA | WSA |
| EX-2-1 | 5/0.2 | 65.52 | 29.99 | 4.50 | >160° | <5° |
| EX-2-2 | 5/0.4 | 65.98 | 29.59 | 4.44 | 159° | <5° |
| EX-2-3 | 5/1.0 | 67.24 | 28.49 | 4.27 | >160 | <5° |
| EX-2-4 | 5/1.5 | 68.14 | 27.70 | 4.16 | >160° | NA |
| EX-2-5 | TEOS only | 64.99 | 30.44 | 4.57 | >160° | <5° |

### Example 3: Preparation of TEOS-PDMS-OH Hybrid Binder

TABLE 2
Composition of hydrolyzed TEOS/PDMS-OH

| | Molar ratio |
|---|---|
| THF | 4 |
| IPA | 1 |
| H₂O | 3 |
| HCl | 0.05 |
| TEOS | 1 |
| TEOS/PDMES-OH (w/w) | 70/30 - 90/10 |

The chemicals and solvents listed below at molar ratios shown in above Table 2, were added to a three-mouth circular flask: THF (CAS109-99-9, sigma-Aldrich), IPA (CAS67-63-0, 99.5%, Sigma-Aldrich) TEOS (CAS78-10-4, 99%, Sigma-Aldrich), PDMS-OH (CAS70131-67-8) and Milli-Q® water (ultrapure water), and dilute aqueous HCl.

PDMS-OH (hydroxy terminated PDMS) with a molecular weight in the range of 400-700 and 2000-3500 was used. Weight ratio of TEOS to PDMS-OH was varied in the range of 70/30 to 95/5.

The mixture was stirred with a magnetic stirrer bar at 80° C. for 30 min under reflux. Then HCl, based on the molar ratio in Table 2 above, was added as a catalyst. The solution was stirred at 80° C. for 30 min under reflux to get the hybrid TEOS/PDMS-OH binder.

Table 3 shows the hydrophobicity of Al₂O₃ nanofiber, silicone microbeads (KMP-605, Shin-Etsu Silicones, Japan) and hybrid binders, in which Al₂O₃ nanofiber was modified as above by perfluoroalkylsilane before making the dispersion of 2.5 wt % in ethanol. In a hybrid binder comprising TEOS and PDMS-OH, hydroxy terminated PDMS with viscosity of 65 centistokes was used which has a molecular weight about 400 to 700 g/mole. As shown in Table 3, hybrid binders having a different weight ratio of TEOS to PDMS-OH were tested. At fixed volume ratio of Al₂O₃ nanofiber dispersion to hybrid binder solution and fixed loading of silicone microbeads, all of the coatings showed superhydrophobic surface properties in terms of water sliding angle.

TABLE 3

| | | FOS- | | | |
|---|---|---|---|---|---|
| | | Al2O3 NF | | Beads | |
| | | (2.5 wt % | Binder | (KMP- | WSA @ |
| Sample ID | Binder | in EtOH) | amount | 605) | 10 ul |
| EX 3-1 | TEOS/ | 10 ml | 0.5 ml | 0.030 g | <5° |
| | PDMS-OH | | | | |
| | (65 cSt) | | | | |
| | 9.5:0.5 (w/w) | | | | |
| EX 3-2 | TEOS/ | 10 ml | 0.5 ml | 0.030 g | <5° |
| | PDMS-OH | | | | |
| | (65 cSt) | | | | |
| | 9.0:1.0 (w/w) | | | | |
| EX 3-3 | TEOS/ | 10 ml | 0.5 ml | 0.030 g | <5° |
| | PDMS-OH | | | | |
| | (65 cSt) | | | | |
| | 8.0:2.0 (w/w) | | | | |
| EX 3-4 | TEOS/ | 10 ml | 0.5 ml | 0.030 g | 10.4° |
| | PDMS-OH | | | | |
| | (65 cSt) | | | | |
| | 7.0:3.0 (w/w) | | | | |

### Example 4: Coating Surface Roughness Measurements

Ethanol dispersion of 2 wt % of Al₂O₃ nanofibers modified by vinyltrimethoxysilane (VTMO) was used in making a coating solution together with silicone microbeads (KMP-605, Shin-Etsu Silicones, JAPAN) and hydrolyzed TEOS binder. The coating was formed on a commercial PET substrate (Hostaphan™ 4507, Mitsubishi Polyester Film, USA) with a doctor blade applicator set at different gaps. Post-CVD treatment on coatings was conducted with 1H,1H,2H,2H-perfluorooctyltriethoxysilane (C₁₄H₁₉F₁₃O₃Si; Gelest Inc. CAS: 51851-37-7) as described above.

A DektakXT® stylus Profilometer (Model Vision64, Bruker) was used to characterize the surface roughness of transparent superhydrophobic coatings comprising Al₂O₃ nanofiber, silicone microbeads and hydrolyzed TEOS binder (See EX-1 above). Surface mapping of 2 mm by 2 mm was performed on the coating samples. Ra, a parameter describing the arithmetic average of absolute values of profile heights are listed in the Table 4, together with water contact angle (WCA) and water sliding angle (WSA).

TABLE 4

| | Casting | Al₂O₃ | silicone | | | | |
|---|---|---|---|---|---|---|---|
| | gap | NF | beads | TEOS | Ra | | |
| Sample | (mil) | (wt %) | (wt %) | (wt %) | (μm) | WCA (°) | WSA (°) |
| EX-4-1 | 1 | 42.02 | 13.13 | 44.85 | 1.09 | >160 | 4.1 |
| EX 4-2 | 2 | 42.02 | 13.13 | 44.85 | 0.95 | >160 | 2.2 |
| EX 4-3 | 3 | 42.02 | 13.13 | 44.85 | 2.51 | >160 | 8.2 |
| EX 4-4 | 4 | 42.02 | 13.13 | 44.85 | 3.10 | >160 | 3.7 |
| EX 4-5 | 5 | 42.02 | 13.13 | 44.85 | 1.09 | >160 | 2.5 |
| EX 4-6 | 6 | 42.02 | 13.13 | 44.85 | 8.92 | >160 | 4.8 |

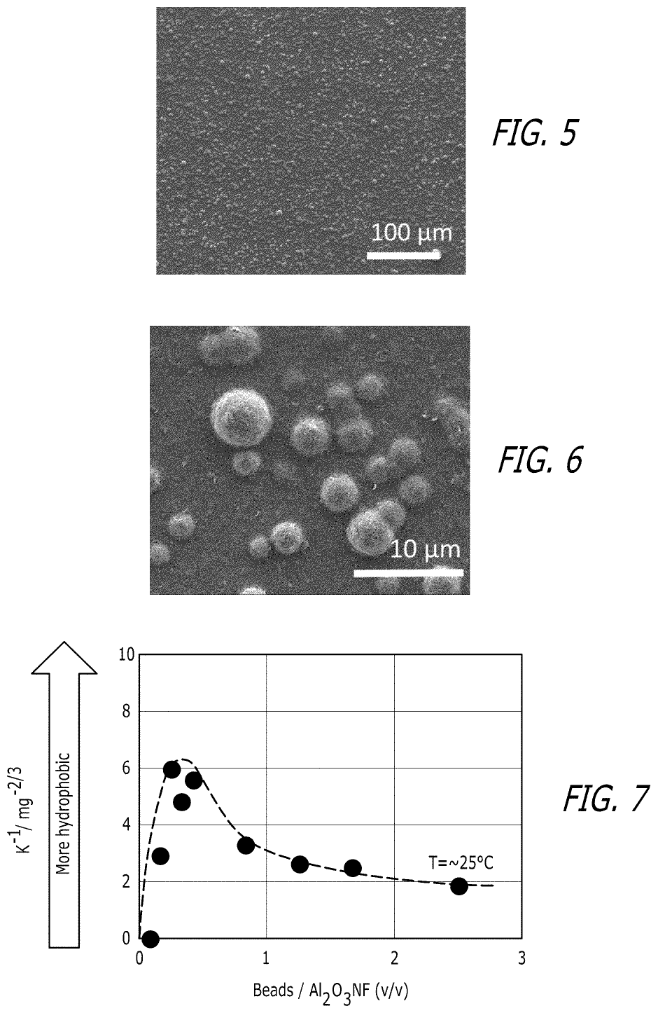

SEM pictures depicting typical surface morphology of the coatings at different magnifications were also shown in FIGS. 5 and 6 below (of which ones above).

A theoretical study (“Effects of the Surface Roughness on Sliding Angles of Water Droplets on Superhydrophobic Surfaces”, Miwa et al. Langmuir 2000, 16, 5754-5760) showed a method to correlate interfacial energy with water sliding angle at different water droplet volume by the following equation

$$sin α = γ {k [ \frac{24 {π}^{2}}{{m}^{2} {g}^{3} p ( 2 - 3 cos {θ}^{′} + {cos}^{3} {θ}^{′} )} ]}^{1 / 3} sin {θ}^{′} \leq 1$$

Where k is interfacial energy, α [alpha] is water sliding angle, Θ′ [theta prime] is equilibrium contact angle on rough surface, m is mass of water drop, g the gravitational acceleration, ρ (rho) is density of water. By simplifying the equation, we have the following equation,

$$sin α = K \times \frac{1}{{( mg )}^{2 / 3}} \leq 1 ,$$

where K is a constant containing the interfacial energy. By measuring water sliding angle at different volume of water droplet and plot sin a (sine alpha) against (mg)^{-2/3}, the value of K can be found from the slope of linear line. The larger slope 1/K the smaller the K value, meaning the better hydrophobicity.

Hydrophobicity of transparent superhydrophobic coating at 25° C., 10° C. and 2° C. was evaluated by using the method above by measuring water sliding angle at different volume of water drop at controlled environment temperature in ambient. A series superhydrophobic coatings were prepared with varied volume ratio of microbeads to Al₂O₃ nanofiber (NF) modified by vinyltrimethoxysilane (VTMO) as shown in Table 5 below.

TABLE 5

| | Al₂O₃ NF | silicone bead | TEOS | beads/Al₂O₃ NF |
|---|---|---|---|---|
| Sample ID | (wt %) | (wt) % | (wt) % | (v/v) |
| EX 5-1 | 45.45 | 6.61 | 47.95 | 0.58 |
| EX 5-2 | 42.63 | 12.39 | 44.98 | 1.17 |
| EX 5-3 | 40.14 | 17.50 | 42.35 | 1.75 |
| EX 5-4 | 37.93 | 22.05 | 40.02 | 2.33 |
| EX 5-5 | 34.16 | 29.79 | 36.04 | 3.50 |
| EX 5-6 | 46.05 | 5.36 | 48.59 | 0.47 |
| EX 5-7 | 46.68 | 4.07 | 49.25 | 0.35 |
| EX 5-8 | 47.32 | 2.75 | 49.93 | 0.23 |
| EX 5-9 | 47.98 | 1.39 | 50.62 | 0.12 |

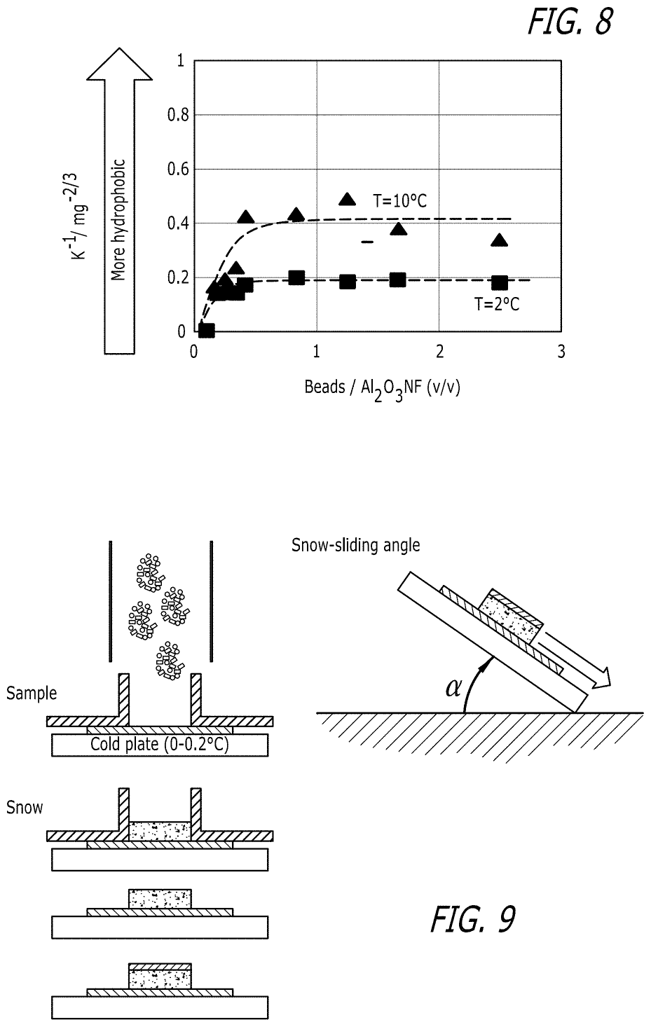

By applying the method above described, i.e. measuring water sliding angle at different volume of water drop and then found the 1/K values from the slopes of sin a vs. mg^{-2/3}. The found 1/K values at 25° C., 10° C., and 2° C. are plotted against volume ratio of microbead to Al₂O₃ nanofiber. Results are depicted in the graphs of FIGS. 7 and 8. As can be seen in FIGS. 7 and 8, at 25° C. the curve showed a maximum in range of 0.35 to 0.47 of volume ratio of microbeads to Al₂O₃ nanofiber. At 10° C. and 2° C., when the volume ratio of microbeads to Al₂O₃ nanofiber is greater than 0.47, the 1/K values become almost unchanged. In consideration of the reduction of transmittance by scattering of incident light with the increase in microbeads loading, the volume ratio of microbeads to Al₂O₃ nanofiber should be maintain below 0.47.

FIGS. 7 and 8 also show the 1/K values decrease with decreasing environment temperature, implying reduced hydrophobicity at lower temperature.

### Example 5: Preparation of a Superhydrophobic Coating Element

Coating Application. The slurry prepared in Example 4 above was cast on a PET film (7.5 cm×30 cm) with a Casting Knife Film applicator (Microm II Film Applicator, Paul N. Gardner Company, Inc.) at a cast rate of 10 cm/s. The blade gap on the film applicator was set at about 5 mils for three samples, with a final wet coating thickness of about 25.4 μm, 50.8 μm and 101.6 μm, respectively. For applications wider than about 2 inches/5.1 cm, an adjustable film applicator (AP-B5351, Paul N. Gardner Company, Inc., Pompano Beach, Fla., USA) was alternatively used.
Drying: The PET was pre-heated to about 40° C. on the vacuum bed of the compact tape casting coater (MSK-AFA-III, MTI Corporation, Richmond, Calif., USA) to increase the solvent evaporation rate. The coated PET was then dried for 1 hour at 100° C. inside an air-circulating oven (105 L Symphony™ Gravity Convection Oven, VWR).

### Example 6: Preparation of Coating Mixture: One Pot Process

18 mL of Al₂O₃ nanofiber dispersion modified by vinyltrimethoxysilane (VTMO) and 9 mL of hydrolyzed TEOS binder in a 100 mL polyethylene jar with lid and mix with centrifuge mixer (THINKY 3000) at 2000 rpm for 2 min. Separately, 1.125 g of silicone microbeads (KMP-605) with average diameter of 2 μm and particle size distribution 0.7-5 μm is dispersed in 10 mL absolute ethanol in 20 mL glass vial in ultrasonication for 1 hour. The silicone microbeads dispersion was added dispersion of Al₂O₃ nanofiber plus hydrolyzed TEOS binder and mixed with centrifuge mixer again at 2000 rpm for 1 min to provide a coating mixture.

Coating mixtures, as shown in table 6 below, were prepared by following the procedures in example 1.2. Ethanol dispersion containing 2.0 wt % of Al₂O₃ nanofiber modified with vinyltrimethoxysilane (VTMO) was used.

A coating was formed onto a soda-lime glass substrate on both sides with dip coater (QPI-168, Qualtech Product Industry Co. Ltd, Denver, Colo., USA) at immersion rate of 100 mm/min and withdraw rate of 100 mm/min. The coating was dried at 100° C. to evaporate the solvent. Water Contact Angle (WCA) was measured with tensiometer (Biolin Scientific) at 10 μl Milli-Q® water and Water Sliding Angle (WSA) was measured with home-made setup at 10 μl Milli-Q® water. T % and haze were measured by Haze meter (HM-150, Murakami Color Research Laboratory, Japan).

The results are listed in Table 6, below.

TABLE 6

| | | Microsphere | TEOS | Al₂O₃ | | | T % | Haze |
|---|---|---|---|---|---|---|---|---|
| Sample | Microsphere | (wt %) | (wt %) | (wt %) | WCA | WSA | (900 nm) | (%) |
| EX 6-1 | KMP-600 | 13.13 | 44.85 | 42.02 | 163° ± 2.7° | 36° ± 2.7° | 90 | 4.7 |
| | (5 μM) | | | | | | | |
| EX 6-2 | KMP-605 | 13.13 | 44.85 | 42.02 | 173° ± 1.7° | 6.7° ± 2.9° | 69 | 11.7 |
| | (2 μm) | | | | | | | |
| EX 6-3 | X-52-1621 | 13.13 | 44.85 | 42.02 | 164° ± 1.5° | 44° ± 4.9° | 88 | 3.1 |
| | (5 μm) | | | | | | | |

### Example 7: Measurement of % Transmittance of Coatings

A 2% dispersion of Al₂O₃ nanofiber modified with vinyltrimethoxysilane in ethanol, hydrolyzed TEOS binder, and silicone microbeads having different sizes, were used as described in previous examples for making coating solution formulations shown in Table 7 below.

Transparent hydrophobic coatings were formed on soda-lime glass substrate by dip coating (QPI-168, Qualtech Product Industry Co. Ltd.) on both sides of a glass substrate. Post-CVD treatment with perfluoroalkylsilane as described above was conducted after the coatings were cured.

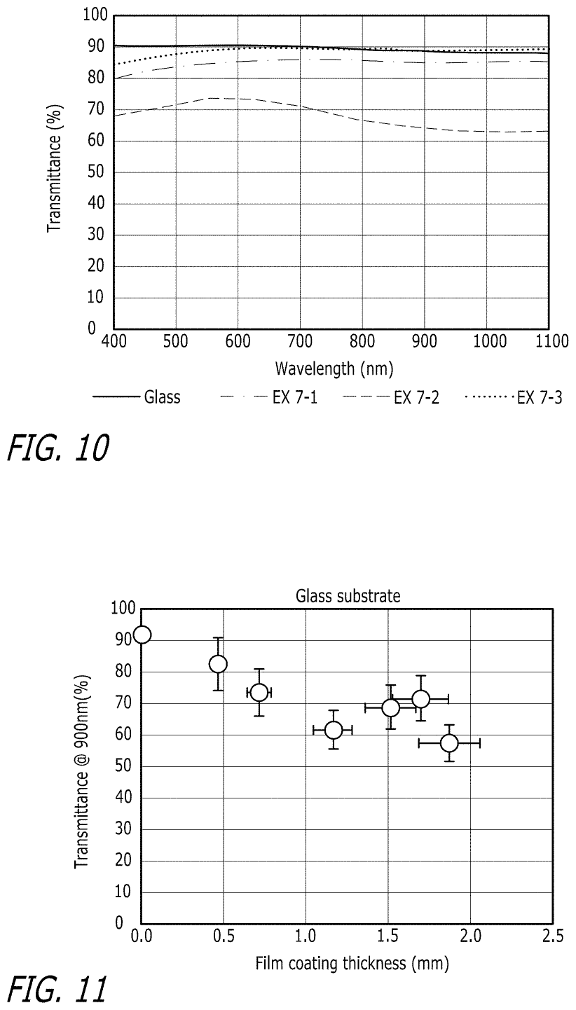

Transmittance of coatings were measured with UV-vis-NIR spectrometer (UV-3600, Shimadzu, Japan) in the wavelength range of 400 nm to 1100 nm. Transmittance spectra were shown in FIG. 10.

TABLE 7

| | Al₂O₃ | TEOS | | |
|---|---|---|---|---|
| | NF/EtOH | Binder | Microspheres | Microsphere |
| Sample | (mL) | (mL) | (g) | Type |
| EX 7-1 | 16 | 0.8 | 0.1 | KMP-600 |
| EX 7-2 | 16 | 0.8 | 0.1 | KMP-605 |
| EX 7-3 | 16 | 0.8 | 0.1 | X-52-1621 |

Dependence of transmittance on coating thickness was estimated by measuring the dry coating thickness on a glass substrate with a Stylus Profilometer (DekTak vision 64 Bruker) and transmittance with a UV-vis-NIR spectrometer (UV-3600, Shimadzu, Japan). The results are shown in FIG. 11.

### Example 8: Performance Testing of Selected Elements

Performance Testing: The elements will be cut into 1.3×2.5 cm swatches and attached to a glass substrate for testing with double sided tape to form a measurement assembly. The contact angle of a drop of water will be measured for the substrates and recorded. Next each individual tape assembly with substrate will be tared on a balance (Mettler-Toledo AG, Greifensee, Switzerland). Then an abrasive surface, sandpaper (600-grit silicon carbide, 3M St. Paul, Minn. USA) will be rubbed against the sample keeping the pressure force between about 1.0-1.3 kg-f for about 100 times. About 5-8 μm of the composition will be ablated away. The test will then be repeated for different selected samples and at different abrasive characteristics. In some measurements, the abrasion tests will be automated with the use of a surface abrasion tester (RT-300, Daiei Kagaju Seiki Manufacturing. Co., Ltd. Sakyo-Kukyoto, Japan). A comparative element using a commercial hydrophobic water repellent coating and primer (Hirec 100, NTT Advanced Technology Corporation, Kanagawa, Japan) will also be assessed.

It is anticipated that the results will show that when exposed to 600 grit sandpaper the elements will initially exhibit superhydrophobicity and should maintain their superhydrophobicity.

Additional tests are planned for selected embodiments where the elements will be subjected to artificial rain and/or snow conditions at various pitch angels ranging from 0 degrees (i.e., flat) to 45 degrees, including 15 degrees and 30 degrees. Then, the accumulation of water and/or snowfall versus angle is planned to be measured for selected samples to determine their durability in simulated environments. The environment in which the samples will be exposed is planned to have temperature ranging from −10° C. to 0° C. to simulate winter conditions. In addition, wind speed of between 0 m/s to 15 m/s, including 5 m/s and 10 m/s will simulate storm conditions. Multiple types of snow accumulation are planned, including the accumulation of flakes and/or the accumulation of graupel (e.g., sleet).

Unless otherwise indicated, all numbers expressing quantities of ingredients, properties such as molecular weight, reaction conditions, and etc. used herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sough to be achieved, and should, therefore, be considered as part of the disclosure. At the very least, the examples shown herein are for illustration only, not as an attempt to limit the scope of the disclosure.

The terms “a,” “an,” “the,” and similar referents used in the contest of the describing embodiments of the present disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or representative language (e.g., “such as”) provided herein is intended merely to better illustrate embodiments of the present disclosure and does not pose a limitation on the scope of any claim. No language in the specification should be construed as indicating any non-claimed elements essential to the practice of the embodiments, of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the embodiments. Of course, variation on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A superhydrophobic coating dispersion comprising:
10 to 75 wt % of an organosilane, wherein the organosilane comprises a low surface energy polymer, a hydrolyzed alkoxysilane, a hydrolyzed fluoroalkylalkoxysilane, or a combination thereof;
20 to 60 wt % hydrophobic inorganic nanofibers disposed within the organosilane;
0.5 to 40 wt % microbeads dispersed in the organosilane; and
a polar solvent.

2. The superhydrophobic coating dispersion of claim 1, wherein the organosilane comprises a C₁ to C₈ alkoxysilane.

3. The superhydrophobic coating dispersion of claim 2, wherein the C₁ to C₈ alkoxysilane comprises a hydrolyzed tetraethoxysilane.

4. The superhydrophobic coating dispersion of claim 1, wherein the organosilane comprises a hydrolyzed 1H,1H,2H,2H-perfluorooctyltriethoxysilane.

5. The superhydrophobic coating dispersion of claim 1, wherein the low surface energy polymer comprises a PDMS-OH.

6. The superhydrophobic coating dispersion of claim 1, wherein the hydrophobic inorganic nanofibers comprise a metal oxide.

7. The superhydrophobic coating dispersion of claim 6, wherein the metal oxide comprises Al₂O₃ nanofibers.

8. The superhydrophobic coating dispersion of claim 7, wherein the Al₂O₃ nanofibers are coated with 1H,1H,2H,2H-perfluorooctyltriethoxysilane.

9. The superhydrophobic coating dispersion of claim 7, wherein the Al₂O₃ nanofibers are coated with vinyltrimethoxysilane.

10. The superhydrophobic coating dispersion of claim 1, wherein the microbeads comprise silicone microbeads.

11. A coated substrate, wherein the substrate has been coated with the superhydrophobic coating dispersion of claim 1; and wherein at least a portion of the microbeads extend above the surface of the organosilane, providing a micro-contoured surface morphology sufficient to provide a superhydrophobic effect.

12. The coated substrate of claim 11, further comprising chemical vapor deposition with 1H,1H,2H,2H-perfluorooctyltriethoxysilane on the substrate.

13. A method for making a superhydrophobic coated substrate comprising:
mixing hydrophobic metal oxide nanofibers, silicone microbeads, an organosilane, and a polar solvent to prepare a uniform dispersion;
applying the uniform dispersion to a substrate; and
heating of the applied dispersion to evaporate the polar solvent to afford a dried applied dispersion coating.

14. The method of claim 13, further comprising chemical vapor deposition of 1H,1H,2H,2H-perfluorooctyltriethoxysilane upon the dried applied dispersion coating.

15. The method of claim 13, wherein the hydrophobic metal oxide nanofibers are between 20 wt % to 60 wt % of the total weight of the uniform dispersion.

16. The method of claim 13, wherein the silicone microbeads are between 0.5 wt % to 40 wt % of the total weight of the uniform dispersion.

17. The method of claim 13, wherein the organosilane is 10 to 75 wt % of the total weight of the uniform dispersion.

18. The method of claim 13, wherein the organosilane is hydrolyzed tetraethoxysilane, hydrolyzed 1H,1H,2H,2H-perfluorooctyltriethoxysilane, PDMS-OH, or a combination thereof.

19. The coated substrate of claim 11, wherein the superhydrophobic coating dispersion is disposed upon a first surface of the substrate, and the substrate further comprises a second surface opposite the first surface, and wherein an adhesive is disposed upon the second surface.

20. A coating made in accordance with the method of claim 13.
